(19) United States
(12) Patent Application Publication
(10) Pub. No.: US 2007/0206120 A1
(43) Pub. Date: Sep. 6, 2007

(54) Double screen television

(76) Inventor: Maurice Antonio Nottage, Upper Marlboro, MD (US)

Correspondence Address: Maurice Nottage, 1901 Willow Switch Lane, Upper Marlboro, MD, 20774, US

(21) Appl. No.: 11/368,239

(22) Filed: Mar. 3, 2006

(51) Int. Cl. H04N 9/74

(52) U.S. Cl. 348/588; 348/836

(57) ABSTRACT

A television view system that has a single base with two flat screens situated thereon. Each flat screen is operable independently of the other flat screen. Channel changing, volume control and picture control are independent to each flat screen, thereby allowing the viewing of more than one channel simultaneously. Strategically positioned in a room, the instant invention can replace the need for multiple televisions.

### PRIOR APPLICATION

This application emanates from a prior Provisional Patent Application filed Jun. 2, 2005.

### FIELD OF THE INVENTION

This invention relates to the field of televisions, specifically a television viewing system that allows for the viewing of more than one television on a single unit.

### BACKGROUND OF THE INVENTION

Television viewing has been an American pastime for decades. Additionally, technology has advanced in television viewing at a rapid rate. Recent technology involves the ability to view television programming on flat screens. Prior art exists, additionally, that allows for the viewing of more than one channel simultaneously on the same screen.

Some examples of such double-screen technology include the capacity for viewing two channels on wide screen televisions described by Ahn in U.S. Pat. No. 5,729,300 and U.S. Pat. No. by Kang. Heretofore, however, there has not been a television viewing system described that allows for the viewing of two different channels on a double-sided system allowing for viewing from multiple perspectives inside a room. Accordingly, there exists a need for a television viewing system that includes two flat screens that are positioned opposite for one another to allow for flexibility of space in a room as well as providing the opportunity for more than one simultaneous television viewing experience.

### SUMMARY OF THE INVENTION

In the preferred embodiment of the invention, a television viewing system is described that is a single unit with a single base. On this base are mounted two flat screen televisions, opposite from each other and projecting the picture in opposite directions. Each screen is independently controlled with traditional television functions known in the art, such as volume control, channel changing and picture control. Positioned strategically in a room, the instant invention can eliminate the need for multiple television sets.

### OBJECT OF THE INVENTION

The principal object of the invention is to provide for the viewing of more than one television channel from one single unit, said single unit having two flat screens positioned adjacent and back-to-back to each other with independent controls while facing the screens in opposite directions from each other.

### BRIEF DESCRIPTION OF THE DRAWINGS

FIG. 1 illustrates a perspective view of the invention.

FIG. 2 illustrates a front view of the invention.

FIG. 3 illustrates a back view of the invention.

### DETAILED DESCRIPTION OF AN ENABLING AND PREFERRED EMBODIMENT

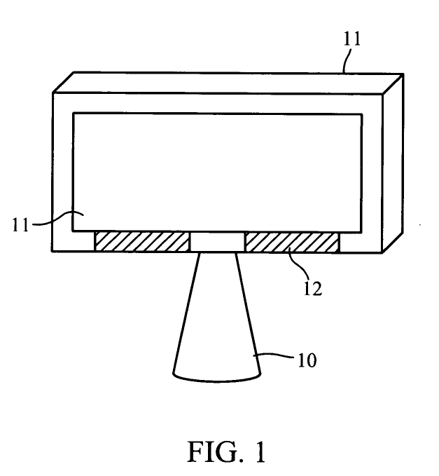

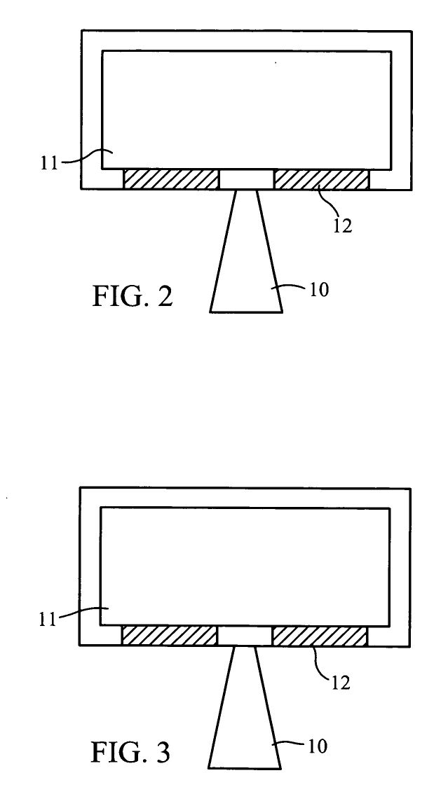

For a better understanding of the invention, we turn now to the drawings. FIGS. 1-3 offer varying views of the invention. The invention can be rotated 360 degrees in any direction. The essential components of the invention are the base 10 and two flat screens 11 situated adjacent, back-to-back and facing in opposite directions from each other. Each flat screen 11 has its own independent controls 12 for channel changing, volume control and picture control. Means for operating these controls are known in the art and nothing prevents any known art from being utilized in the instant invention. As with all television systems, the instant invention requires the use of a power source (not shown), such as an A/C adapter for plugging into an electrical outlet.

The illustrations and examples provided herein are for explanatory purposes and are not intended to limit the scope of the appended claims, as those skilled in the art will make modifications to the invention for particular uses.

I claim:

1. A television viewing system comprising
a base;
a first flat screen for viewing television programming, said first flat screen being attached to said base;
a second flat screen positioned adjacent to and in the opposite direction from said first flat screen, said second flat screen being attached to said base;
two separate means for operating traditional television functions, such as channel changing, volume control and picture control to each of said flat screens so that viewers can operate each flat screen projection separately from the other;
a power source.
